(19) United States
(12) Patent Application Publication
(10) Pub. No.: US 2005/0061137 A1
(43) Pub. Date: Mar. 24, 2005

(54) Reed for single-reed woodwind instruments

(76) Inventor: Philip L. Rovner, Timonium, MD (US)

Correspondence Address: Royal W. Craig;Law Offices of Royal W. Craig, Suite 153, 10 N. Calvert Street, Baltimore, MD, 21202, US

(21) Appl. No.: 10/947,104

(22) Filed: Sep. 22, 2004

Related U.S. Application Data
(60) Provisional application No. 60/504,994, filed on Sep. 22, 2003.

(51) Int. Cl. G10D 7/02

(52) U.S. Cl. 84/383 A

(57) ABSTRACT

A reed for single-reed woodwind instruments formed of natural cane wood and comprising a heel section and a tapered tip section. The heel's top surface comprises the bark of the cane, and the remainder of the reed constitutes natural cane wood fibers or “grain.” A plurality of slits are cut into the top surface of the heel section in a direction consistent with and parallel to the grain of the cane wood. Each slit extends through, and along the length of, the layer of cane bark, creating a discontinuous bark structure (but preferably not disturbing the underlying cane wood grain). This discontinuous bark structure prevents the cane bark from causing the reed to warp as the wood fibers expand (more rapidly than the bark) due to the absorption of moisture during each initial period of use. This prevention of warping allows the reed to maintain its response, tone, and power.

### CROSS-REFERENCE TO RELATED APPLICATIONS

The present application derives priority from U.S. Provisional Patent Application 60/504,994 for “REED FOR SINGLE-REED WOODWIND INSTRUMENTS”, filed Sep. 22, 2003.

### BACKGROUND OF THE INVENTION

1. Field of the Invention

The present invention relates to musical instruments and, more particularly, to woodwind instruments that utilize a single reed affixed to a mouthpiece, and even more particularly, to a reed that exhibits improved performance through increased resistance to warping.

2. Description of the Background

In single-reed woodwind instruments, such as clarinets and saxophones, the form and functionality of the reed, which is attached to the mouthpiece, is critical to the overall sound (i.e. response, power, tonality) of the musical instrument. For the reed to function properly, its flat underside must conform closely to the flat table of the mouthpiece to prevent any leakage from the instrument's air column. Unfortunately, there is a tendency for the reed to temporarily warp during the initial period of each use, and that warping typically allows one or more gaps to form between the reed and the mouthpiece's table. The formation of one or more gaps causes the tone of the instrument to become, at best, “stuffy” or, at worst, non-existent.

The tendency for a reed to warp during the initial period of each use is directly related to the combination of its physical configuration and the structure of the cane wood from which it is fabricated. A reed is manufactured from a section of the cane proximate its outer surface and encompasses both its external bark and internal wood fibers. The curved, top surface of the reed's heel incorporates the cane bark while internal wood fibers constitute the remainder of the reed, including the heel's flat underside and the entire length of the tapered tip section. During each initial period of a reed's use, as it begins to absorb moisture from the mouth of the user (i.e., musician), it becomes temporarily warped because the internal wood fibers absorb that moisture more rapidly than the cane bark. The unequal rate of moisture absorption leads to an unequal rate of dimensional expansion between the internal and external elements of the cane, thereby causing the normally flat underside of the reed to, at least temporarily, assume a convex curvature. This convex curvature causes separation (i.e. the formation of one or more gaps) between the temporarily curved underside of the reed and the mouthpiece's flat table, creating air leaks and a consequent degradation in the performance of the reed and the instrument to which it is attached.

Prior efforts to address the problem outlined above have included the cutting of slots in the heel of the reed to increase its level of vibration. However, those efforts resulted in the removal of a substantial amount of material, both bark and wood fibers, from the reed, resulting in a tonal quality that was thin and lacking in body. To the best of the knowledge of the present inventor, a reed construction/configuration resolving the problem outlined above does not exist. Therefore, there remains a need for an apparatus that provides a substantial degree of utility by offering increased resistance to warping, thereby maintaining the response, tone, and power of the attached instrument throughout a reed's initial period of use. The apparatus, or elements thereof, should also be scalable to provide for use in a variety of musical applications, capable of being fitted to all existing, single-reed woodwind instruments, and economical to manufacture to provide for widespread use.

### SUMMARY OF THE INVENTION

It is, therefore, the primary object of the present invention to provide an improved reed for use in single-reed woodwind instruments.

It is another object of the present invention to provide an improved reed that resists the temporary warping that typically occurs during each initial period of use, thereby maintaining the response, tone, and power of the attached instrument.

It is still another object of the present invention to provide an improved reed that enhances the intonation of the attached instrument.

It is another object of the present invention to provide an improved reed that is scalable to provide for use in a variety of applications.

Yet another object of the present invention to provide an improved reed that may be fitted to all existing single-reed woodwind instruments.

Still another object of the present invention is to provide an improved reed that is economical to manufacture to provide for widespread use.

These and other objects are accomplished by a reed that generally comprises a heel section with a plurality of narrow, shallow slits, and a tapered tip section. The heel section possesses a curved top surface (across the width of the reed) and a flat underside. The tip section tapers from a maximum thickness at its interface with the heel section to a minimum thickness at a distal end of the reed. The underside of the tip section is flat while the top surface is slightly curved (along the length of the reed) due to the reed's tapering thickness. The heel's top surface and a thin layer of material just below that top surface is made up of the bark of the cane. Internal wood fibers of the cane constitute the remainder of the reed. The plurality of slits are cut into the top surface of the heel section in a direction that is parallel to the grain of the cane wood (typically the reed's longitudinal axis). Each slit extends through, and along the length of, the layer of cane bark only, thereby creating a discontinuous bark structure. The discontinuous bark structure prevents the cane bark from causing the reed to warp as the wood fibers expand (more rapidly than the bark) due to the absorption of moisture during each initial period of use, thereby maintaining the response, tone, and power of the attached instrument. Additionally, the plurality of slits improves the intonation of any instrument to which the present invention is attached. Elements of the present invention are scalable to provide for use in a variety of musical applications. The present invention may be fitted to all existing single-reed woodwind instruments, and is economical to manufacture, which provides for widespread use.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a top perspective view of a reed 10 according to a preferred embodiment of the present invention.

FIG. 2 is an end perspective view of the reed 10 of FIG. 1.

FIG. 3 is a side perspective view of the reed 10 of FIGS. 1 and 2.

### DETAILED DESCRIPTION OF THE PREFERRED EMBODIMENTS

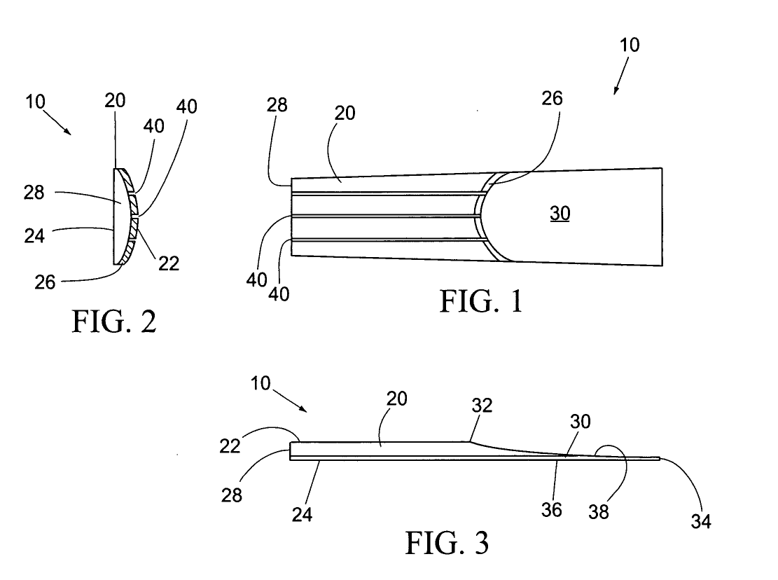

FIGS. 1-3 are, respectively, top, end, and side perspective views of a reed 10 according to a preferred embodiment of the present invention.

The reed 10 generally comprises a heel section 20 with a plurality of narrow, shallow slits 40, and a tapered tip section 30. The heel section 20 possesses a curved top surface 22 (across the width of the reed 10) and a flat underside 24. The tip section 30 tapers from a maximum thickness at its interface 32 with the heel section 20 to a minimum thickness at a distal end 34 of the reed 10. The underside 36 of the tip section 30 is flat while the top surface of the tip section 38 is slightly curved (along the length of the reed 1 0) due to the reed's tapering thickness. The heel's top surface 22 and a thin layer 26 of material just below that top surface 22 is made up of the bark of the cane. Internal wood fibers of the cane constitute the remainder of the reed 10. The reed 10 is preferably a unitary component fabricated from a section of commercially-available cane wood. However, other materials such as plastics may be utilized in the fabrication of the reed 10.

The plurality of slits 40 are preferably cut into the top surface 22 of the heel section 20 in a direction parallel to and consistent with the grain of the cane wood (typically the reed's longitudinal axis). In the preferred embodiment, each slit 40 extends through, and along the length of, the layer 26 of cane bark only—no portion of the internal wood fibers are removed or disturbed—thereby creating a discontinuous bark structure on the top surface 22 of the heel section 20. The preferred depth of each slit 40 is determined by, and is equivalent to, the thickness of the bark layer 26 at the point where the slit 40 is cut. Alternative embodiments of the present invention may incorporate deeper slits 40 resulting in alternative tonalities for the instruments to which the reeds 10 are attached. The preferred width of the slit 40 should not exceed 0.010″. The length of each slit 40 may vary and is determined by the length of the bark layer 26 from the interface 32 between the heel section 20 and the tip section 30 to the distal end 28 of the heel section 20. Each slit 40, therefore, removes only a minimal amount of cane bark material from the overall structure of the reed 10.

During each initial period of reed 10 usage as the reed 10 absorbs moisture from the musician's mouth, the discontinuous bark structure prevents the cane bark from causing the reed 10 to warp as the wood fibers expand (more rapidly than the bark). This prevention of warping allows the reed 10 to maintain the response, tone, and power of the attached instrument. In addition, it has been determined that the presence of the plurality of slits 40 improves the intonation of any instrument to which the reed 10 of the present invention is attached. Typically, the number of slits 40 range from three to five. However, the location/arrangement and number of slits 40 cut into the heel section 20 may be varied to optimize the tonal response/quality of the attached instrument, or to suit the personal taste or preference of a user.

Elements of the present invention are scalable to provide for use in a variety of musical applications. The present invention may be fitted to all existing single-reed woodwind instruments and is economical to manufacture, thereby providing for widespread use.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

1. A reed for a woodwind instrument, comprising:
a heel section formed of cane wood having a layer of cane bark, and a plurality of longitudinal slits cut into a surface of said heel section through said cane bark; and
a tapered tip section adjoining said heel section.

2. The reed according to claim 1 wherein said plurality of slits are cut into said heel section along a natural grain of the cane wood.

3. The reed according to claim 1 wherein said plurality of slits are cut through the cane bark only without disturbing the cane wood, thereby forming a discontinuous cane bark layer on a top surface of the heel section.

4. A reed for a single-reed woodwind instrument, comprising:
a heel section, said heel section defined by a curved top surface and a flat underside;
a tapered tip section adjoining said heel section, said tip section defined by a curved top surface and a flat underside, and tapering from a maximum thickness at an interface with said heel section to a minimum thickness at a distal end of said reed;
and a plurality of longitudinal slits cut into said top surface of said heel section.

5. The reed according to claim 4 wherein said curved top surface of said heel section comprises a layer of cane bark.

6. The reed according to claim 5 wherein each of said plurality of slits is cut to a depth that is equal to a thickness of said layer of cane bark.

7. The reed according to claim 5 wherein each of said plurality of slits is cut to a depth exceeding a thickness of said layer of cane bark.

8. The reed according to claim 5 wherein each of said plurality of slits is cut to a width that is less than or equal to 0.010″.

9. The reed according to claim 5 wherein said plurality of slits are in a direction parallel to a natural grain of said cane wood.
